(19) United States
(12) Patent Application Publication
(10) Pub. No.: US 2014/0244354 A1
(43) Pub. Date: Aug. 28, 2014

(54) METHOD AND A SYSTEM FOR PREDICTING BEHAVIOUR OF PERSONS PERFORMING ONLINE INTERACTIONS

(71) Applicant: SITECORE A/S, Kobenhavn (DK)

(72) Inventor: Michael SEIFERT, Charlottenlund (DK)

(73) Assignee: SITECORE A/S, Kobenhavn (DK)

(21) Appl. No.: 13/776,203

(22) Filed: Feb. 25, 2013

(51) Int. Cl. G06Q 30/02

(52) U.S. Cl. CPC G06Q 30/0202
USPC 705/7.31

(57) ABSTRACT

A person performs online interactions with an entity, and one or more interactions are registered as a partial sequence of interactions. The partial sequence is compared to stored sequences and associated final events defining an outcome, of persons who have previously performed interactions with the entity. A final event and/or a probability of a final event of the partial sequence is/are predicted, based on the comparing step.

### FIELD OF THE INVENTION

The present invention relates to a method and a system for predicting behaviour of persons performing online interactions with an entity, for instance visitors visiting a website. More particularly, the method and system of the invention allow an entity, such as a website owner, to predict a likely final outcome of a sequence of online interactions between a person and the entity, thereby allowing the entity to focus marketing efforts.

### BACKGROUND OF THE INVENTION

When marketing products or services, various communication channels and various approaches may be used in order to reach potential customers. For instance, online marketing, including advertising and/or selling products and/or services via websites may be used as one communication channel. Another communication channel could be approaching potential customers via telemarketing, printed advertisements, etc. In some cases the vendor of the products or services may keep track of when and how specific potential customers have been approached. This may be done using a customer relations management (CRM) system. However, the information contained in such a CRM system alone will normally not provide a vendor with enough information regarding how and where to focus, e.g., marketing efforts in order to maximise the chances of successfully fulfilling the goals of the vendor, e.g. with respect to maximising the number of closed purchase deals, the total turnover or the number of new customers.

US 2011/0119108 discloses a method for modelling behaviour of a visitor to an e-commerce location. One or more visitor characteristic values are obtained, and a model of the visitor's behaviour is developed according to a nonlinear state estimation technique. A set of visitor behaviour characteristic values is then estimated with the model that best matches the visitor's behaviour.

### DESCRIPTION OF THE INVENTION

It is an object of embodiments of the invention to provide a method for handling customer relations, the method allowing a vendor to predict a likely final outcome of marketing contact with a customer.

It is a further object of embodiments of the invention to provide a method for handling customer relations, the method allowing a vendor to focus marketing efforts on potential customers where the marketing efforts have a high probability of leading to success.

According to a first aspect the invention provides a method for predicting behaviour of a person performing online interactions with an entity, the method comprising the steps of:
allowing a plurality of persons to perform online interactions with the entity,
for each person:
   registering a sequence of one or more online interactions between the person and the entity, said online interaction(s) taking place between an initial contact between the person and the entity, and a final event,
   registering a final event, said final event defining an outcome,
   associating the final event with the sequence of online interactions, and storing information regarding the sequence of online interactions along with information regarding the final event in a storage device,
allowing a further person to perform online interactions with the entity,
registering one or more online interactions between the further person and the entity, said one or more online interaction(s) forming a partial sequence of online interactions,
comparing the partial sequence of online interactions to previously stored information regarding sequences of online interactions and final events, and
predicting a final event and/or a probability of a final event of the partial sequence of online interactions, based on said comparing step.

The entity may, e.g., be a vendor, a website owner, an organisation and/or any other suitable kind of entity which requires online interactions with persons.

In the present context the term ‘online interaction’ should be interpreted to include any kind of interaction or contact between the person and the entity or a representative for the entity, which takes place via online communication means, such as via a computer network. For instance, the online interactions may include visits to a website, online chats, etc.

According to the method of the first aspect of the invention a plurality of persons are allowed to perform online interactions with the entity. For each of the persons a sequence of one or more online interactions is registered. The online interaction(s) of the sequence take place between an initial contact between the person and the entity and a final event. Thus, the initial contact initiates the sequence or marks the beginning of the sequence, and the final event completes or ends the sequence. The final event may take place during the initial contact, in which case the sequence will only comprise one online interaction. Alternatively, the sequence may comprise two or more online interactions.

The initial contact may be the first contact between the person and the entity. However, the first contact may, alternatively, be the first contact between the person and the entity following a previous final event, the first contact between the person and the entity following the launch of a marketing campaign, and/or the first contact between the person and the entity within a selected time period. Alternatively, any other suitable criteria may be used for defining the first contact between the person and the entity.

It could be envisaged that, over time, several final events occur between a given person and the entity. In this case, sequences may be registered which comprise online interactions taking place between one final event and the following final event. Alternatively or additionally, one single sequence, comprising all online interactions and all final events may be registered. Finally, sequences comprising two or more final events following each other, but not all online interactions between the person and the entity, may alternatively or additionally be registered.

Next a final event is registered. The final event is an event which defines an outcome, and which takes place after the sequence of online interactions between the person and the entity. The final event may be an online or an offline event. The final event may, thus, be a result of the online interactions, and/or actions performed during the online interactions, between the person and the entity, which took place prior to the final event.

The final event may, e.g., be or include closing a sales agreement or a service agreement, the person requesting a demo, the person signing up for a newsletter, the person buying products or services online, the person discontinuing or abandoning contact with the entity, and/or any other suitable kind of event which the entity may regard as an ‘outcome’ of, possibly repeated, contact or interaction with the person. The final event may be associated with a value, such as a generated revenue, revenue equivalent or an estimated loss.

The final event is then associated with the sequence of online interactions, and information regarding the sequence of online interactions is stored along with information regarding the final event for that person. Since the final event takes place either after or in immediate connection with the sequence of online interactions, there may very well be a correlation between the online interactions of the sequence of online interactions and the final event. For instance, as described above, the final event may be an outcome or a consequence of the online interactions, and/or actions performed during the online interactions, of the sequence of online interactions leading up to the final event. However, the final event may also be at least partly due to other factors or circumstances which are unrelated to, or at least not directly related to, the sequence of online interactions. However, in order to investigate this, it is relevant to associate the final event to the sequence of online interactions, and to store information regarding the sequence of online incidents along with information regarding the final event.

Performing the steps described above for a plurality of persons results in a large amount of correlated information regarding sequences of online interactions and final events being obtained and stored in the storage device, thereby providing statistical material which can be used for analysing how the persons behaved during the online interactions and/or between the online interactions, and/or which kind of online interactions result in which final events.

Once a ‘bank’ of information has been obtained, as described above, a further person is allowed to perform online interaction with the entity. The further person may be a person which has not previously performed online interactions with the entity. Alternatively, the person may be one of the plurality of persons who performed the online interactions with the entity in order to obtain the correlated information described above.

Next one or more online interactions between the further person and the entity are registered, similarly to the situation described above. The registered online interactions form a partial sequence of online interactions in the sense that a final event has not yet occurred, and the sequence of online interactions is therefore not yet complete.

The partial sequence of online interactions is then compared to the previously stored information regarding sequences of online interactions and final events. Based on this comparison, a final event and/or a probability of a final event of the partial sequence of online interactions is/are predicted.

As described above, the stored information regarding sequences of online interactions and final events represents statistical and historical material regarding the behaviour of persons who have previously performed online interactions with the entity. In particular, the stored information provides correlated information regarding sequences of online interactions and final events. Therefore, comparing the partial sequence of online interactions with the stored information allows the future behaviour of the person who has performed the online interactions of the partial sequence to be predicted, based on a statistical analysis of actual behaviour of actual persons who have previously performed online interactions with the entity. In particular, it is possible to predict a likely outcome of the partial sequence of online interactions, in the form of a likely final event resulting from the online interactions of the partial sequence, possibly including an estimated revenue or loss. Furthermore, since the prediction is made on the basis of a statistical material obtained from actual behaviour of a large number of actual persons performing online interactions with the entity, the prediction is likely to be very accurate, at least in many cases. Alternatively or additionally, the probability of a given final event, or the probabilities of two or more possible final events, may be predicted on the basis of the comparison.

The prediction may include predicting a value, such as a generated revenue, revenue equivalent or an estimated loss.

In some cases, the prediction may become increasingly more accurate as more interactions between the entity and the person take place. This may be the case when a final event is predicted as well as when the probability of one or more possible final events is predicted. For instance, after the first interaction between the entity and the person, the probability of final event A may be 25%, the probability of final event B may be 65%, and the probability of final event C may be 10%. This distribution of probabilities may be communicated to the entity. Alternatively or additionally, the probabilities described above, may lead to the conclusion that final event B is the most probable final event, and the result of the comparison may therefore be a prediction that final event B will occur. However, this prediction will only be given with 65% certainty. When some time has been allowed to lapse, and the person has performed several interactions with the entity, the probabilities of the final events may have changes, for instance the probability of final event A may be 0%, the probability of final event B may be 92%, and the probability of final event C may be 8%. Once again, this distribution of probabilities may be communicated to the entity, and/or the result of the comparison may be a prediction that final event B will occur. The latter conclusion does not differ from the conclusion after the first interaction. However, the prediction is now given with 92% certainty, i.e. the prediction is much more likely to be correct. A situation could be envisaged in which the distribution of probabilities changes in such a manner that another final event becomes the most likely final event. In this case the prediction will change over time.

The prediction of a final event and/or a probability of a final event allows the entity to act in a manner which increases the probability of a desired outcome, or final event, resulting from the interactions with the further person. For instance, if the comparison reveals that it is very likely that the partial sequence of online interactions results in the further person interrupting or abandoning contact with the entity, thereby leading to a potential loss or missed sales opportunity for the entity, the entity may contact the further person, e.g. via a telephone call or via e-mail, in order to maintain the contact with the further person, and possibly preventing abandonment, and thereby a potential loss. Furthermore, the entity may provide a relevant and contextual experience to an online visitor, in real-time. As another example, the comparison may reveal that the probability of a desired income will increase significantly if a follow-up e-mail is sent to the further person at a specific time, then the entity may choose to send such a follow-up e-mail. As yet another example, the comparison may reveal that the probability of a desired outcome is almost 100%. In this case the entity may choose not to contact the further person, and instead focus marketing efforts on other persons, where it appears that an effort will increase the likelihood of a desired outcome. As yet another example, the comparison may reveal that the probability of an undesired outcome, such as abandonment or loss, is almost 100%, and that an effort from the entity is not likely to increase the probability of a desired outcome. In this case, the entity may determine that an effort towards this further person is not worthwhile, and the entity may therefore accept the undesired outcome and focus marketing efforts on other persons.

The actions performed by the entity described above may even be performed automatically by the system. For instance, the system may comprise an execution module which is capable of generating e-mails, personalizing webpages, notifying sales personnel that a telephone call is required, etc., based on the prediction.

When the entity intervenes in the sequence of interactions as described above, the probabilities of a one or more possible final events occurring may be affected. The new sequence of interactions will eventually be registered along with the final event associated thereto, and it will thereby form part of the ‘bank’ of information which is used for predicting final events of future sequences of interactions. Thus, the entity may use the method for ‘testing’ various interventions in the sequence of interactions with a person in order to investigate how such intervening interactions actually affect the final outcome.

Thus, based on the prediction, the entity may perform one or more actions towards the further person, e.g. in the form of one or more further online or offline interactions.

At least some of the online interactions may be visits to a website by the person. The website may advantageously belong to the entity. Alternatively, the entity may represent the owner of the website, e.g. as a marketing agent or the like.

The information being stored regarding the sequence of online interactions may comprise: time of interactions, duration of interactions, actions performed during interactions, time lapsing between interactions, location of the person, means of online interaction, value generated during interactions, content viewed by the person during interactions and/or time lapsing while viewing content. Alternatively or additionally, other suitable information may be stored, e.g. a relative value of the interaction. A relative value of an interaction could, e.g., be a monetary amount, or a value assigned to interaction based on their relative importance. The latter may be referred to as ‘engagement value’.

The time of an interaction is the specific time at which the interaction took place. In the case that the interaction has a certain duration, the time of the interaction could, e.g., refer to the starting time or the ending time of the interaction. The time of an interaction may be very specific, e.g. referring to an exact date and time of date. Alternatively, the time of an interaction may be less specific, e.g. referring merely to the date at which the interaction took place. In the case that the sequence of interactions comprises two or more interactions, storing information regarding the time of the interactions provides an overview of when specific interactions took place, relative to each other.

The duration of an interaction is the time it took to perform the interaction. For instance, in the case that the interaction is the person visiting a website, the duration of the interaction could, e.g., be the time the person spent on the website.

An action performed during an interaction could be any kind of action which the person or the entity performs during a given interaction. For instance, in the case that the interaction is the person visiting a website, actions performed during the interaction could be navigations and/or actions performed by the user, at the website, during the visit. Another example could be the person responding to a campaign e-mail and/or activating a link in an e-mail or on a webpage. An action performed during an interaction could very well constitute a final event. This may, e.g., be the case if the action is the person purchasing a product, closing a sales agreement, requesting a demo or signing up for a newsletter during a visit on a website, during a live chat, or in response to a campaign e-mail. Information regarding actions performed during the interactions provides more specific information regarding the behaviour of the person than merely information regarding the nature of the interactions. Thus, a more accurate prediction of the behaviour of a further person can be obtained when the stored information contains information regarding actions performed during the interactions.

A time lapsing between interactions is the duration of time between the time of one interaction and the time of the immediately following interaction. This may be useful information for predicting whether a person is likely to close a sales agreement, or the person is more likely to interrupt or abandon the contact with the entity. For instance, an analysis may reveal that when the time between two interactions exceeds a given threshold value, the probability of the person abandoning the contact to the entity increases dramatically. Thus, the entity may choose to actively contact the person if the time since the last interaction approaches this threshold value.

The location of the person could, e.g., be a country or region where the person is located while performing the online interactions, and/or a country or region of residence of the person. Persons living in various countries or regions may behave in various manners when interacting with an entity, and the location of the person may therefore have an influence on the final outcome or the final event of the interactions between the person and the entity. Therefore, in some cases, it may be relevant to consider the location of the person when predicting the final event.

The means of online interaction may, e.g., include the method by which the person accesses or contacts the entity and/or a device which the person uses for accessing or contacting the entity. The means of online interaction may, thus, include browsing a website, sending or receiving an e-mail, online chats, a mobile phone, a personal computer, a tablet, etc.

Value generated during an interaction could be monetary value, such as the price of products or services purchased or ordered during the interaction. Alternatively, the value generated during an interaction could be a value assigned to the interaction, which reflects the interaction's estimated relative impact on the final outcome.

Content viewed by the person during interactions could, e.g., be content of a website being visited by the person. As another example, it could be contents of a live demo.

Time lapsing while viewing content could, e.g., be the time which the person spends on viewing content of a website or while viewing a live demo.

The step of storing information regarding the sequence of online interactions may comprise storing information regarding events taking place during at least one online interaction. Such events could, e.g., be or comprise actions and/or navigations performed by the person or the entity during the online interaction. According to this embodiment, the stored information does not only include information regarding the sequence of interactions, such as time lapsing between the interactions, kinds of interactions, order of the interactions, etc., but the information also includes information regarding what took place during the individual interactions. Such information may, in some cases, be more relevant than information regarding the sequence of interactions as such, and it may therefore be an advantage to include such information for the purpose of predicting the final event.

The final events may be selected from a group consisting of: purchase, abandonment, requesting a demo, downloading an asset, signing up for a newsletter, unsubscribing from a newsletter, filling in a form, a revenue and a loss. Alternatively or additionally, any other suitable event could constitute a final event, as long as the event represents an outcome, where the entity is interested in knowing whether or not, and to which extent the outcome occurs, e.g. various kinds of signing up, subscription, unsubscription, etc.

The method may further comprise the steps of, for one or more of the plurality of persons and/or for the further person:
registering one or more offline interactions between the person and the entity,
associating the offline interaction(s) with the sequence of online interactions, and
storing information regarding the offline interaction(s) along with the information regarding the sequence of online interactions and the information regarding the final event.

The offline interaction(s) may be selected from a group consisting of: telephone contact, meeting, and mailed purchase offer. Alternatively or additionally, other kinds of offline interactions could be envisaged.

According to this embodiment, the interactions between the person and the entity include online interactions as well as offline interactions. The online interactions and the offline interactions may be registered separately, e.g. as separate sequences being associated to each other. Alternatively, the offline sequences may simply be registered as forming part of the sequence of interactions, the sequence thereby comprising online interactions as well as offline interactions.

According to this embodiment, a single overview of all interactions between a person and the entity is obtained. An outcome, and thereby a final event, may very well be the result of a combination of online interactions and offline interactions between the person and the entity. Accordingly, such a single overview of all interactions may be very valuable for evaluating why a specific final event occurred, and may therefore provide a valuable tool for predicting the behaviour of a further person interacting with the entity.

Thus, the step of comparing the partial sequence of online interactions to previously stored information regarding sequences of interactions and final events may further comprise comparing registered offline interactions of the further person to stored information regarding offline interactions.

The step of comparing the partial sequence of online interactions to previously stored information regarding sequences of interactions and final events may comprise identifying one or more stored sequences of online interactions comprising a sub-sequence which is identical or similar to the partial sequence. According to this embodiment, it is investigated whether other persons have previously exhibited a behavioural pattern which is identical or similar to the behavioural pattern of the person which is currently interacting with the entity. If this is the case, there is a high probability that the current interactions between the person and the entity will result in the final event which occurred for the previous person(s).

The step of comparing the partial sequence of online interactions to previously stored information regarding sequences of online interactions and final events may comprise analysing the stored information and/or the partial sequence of online interactions. Such an analysis may, e.g., reveal patterns in the behaviour of persons interacting with the entity.

The method may further comprise the step of estimating a number of persons being unknown to the entity becoming known to the entity within a predefined time period, based on the analysis step. Some of the persons who interact with an entity may be unknown to the entity in the sense that the person has not previously interacted with the entity, and/or in the sense that previous interactions have been of minor significance, and/or have not led to an identification of the person. In the case that such persons continue to interact with the entity, the person may at some point be identified by the entity, thereby becoming known to the entity. When a person becomes known to the entity, it must be expected that the probability of the interactions between the person and the entity resulting in an outcome which is desirable for the entity, is increased. According to this embodiment, it is estimated how many of the persons, which are currently unknown to the entity, will become known within a predefined time period. This estimate represents an expected volume of new value generating persons, for instance customers in a pipeline.

The estimate is performed on the basis of the analysis step, i.e. it is performed on the basis an analysis of the stored information regarding sequences of online interactions and final events and/or an analysis of the partial sequence of online interactions. Thus, the behaviour of a person, which is unknown to the entity, may be compared to the behaviour of other persons, who have previously performed online interactions with the entity, and who were initially unknown to the entity. Based on this comparison, the probability of the person becoming known to the entity within the predefined time period can be estimated. By performing this analysis for a number of persons, who are currently unknown to the entity, it is possible to obtain an estimate for the number of unknown persons who will become known to the entity within the predefined time period.

The method may further comprise the step of storing the result of the analysis in the storage device. According to this embodiment, the results of previously performed analyses will also be available when a further person performs online interactions with the entity, and the partial sequence of the further person is being compared to the stored information. This may improve the quality and/or efficiency of the comparing step.

An analysis of the stored information may be performed periodically, alternatively or additionally to performing the analysis when a further person performs online interactions with the entity. Thereby it is ensured that recent analysis results are available when a further person performs online interactions with the entity, and a comparison between the partial sequence of online interactions and the stored information is required. As described above, this may improve the quality and/or efficiency of the comparing step.

The step of analysing may comprise analysing time lapsing between interactions and/or time lapsing between interactions and final events. For instance, if long time intervals lapse between interactions and/or if the time intervals lapsing between interactions are increasing, it may be an indication that the person is losing interest in the entity, and that the probability of a potential loss and/or abandonment is therefore high. For instance, the probability of certain final events may decay, e.g. exponentially, as a function of time, in which case it is very relevant to observe the time elapsing between interactions. On the other hand, if short time intervals lapse between interactions and/or if the time intervals lapsing between interactions are decreasing, it may be an indication that the person shows an increasing interest in interacting with the entity, and that the probability of a desired outcome is therefore high. Thus, time lapsing between interactions and/or time lapsing between interactions and final events is sometimes a suitable parameter for predicting future behaviour of a person and/or an outcome of the behaviour of the person.

The method may further comprise the step of storing information regarding an online interaction in the storage device each time an online interaction has taken place. According to this embodiment, not only the complete sequences of online interactions, along with the corresponding final events, are stored in the storage device. The partial sequences of online interactions are also stored, and the stored information for each person is updated each time an interaction between the person and the entity takes place. Thereby the available information is continuously and dynamically updated, thereby ensuring that the most recent information is always available. Furthermore, in this case the comparison step may take place after the partial sequence of online interactions has been stored. Thereby a stored partial sequence of interactions is compared with stored information regarding previous sequences and associated final events.

The method may further comprise the steps of:
for each person performing online interactions with the entity, determining whether or not the person is related to a group of persons,
in the case that it is determined that the person is related to a group of persons, associating the online interactions performed by the person to sequences of online interactions performed by other persons being related to said group of persons, thereby obtaining a combined sequence of online interactions being associated to said group of persons, and
storing information relating to the combined sequence of online interactions along with information regarding final events being associated to sequences of online interactions forming part of the combined sequence of online interactions.

The group of persons could, e.g., be a household or a business entity.

In the present context the term ‘business entity’ should be interpreted to mean a company, an organisation or the like, having one or more individuals related thereto, e.g. in the form of employees or external agents. It may be envisaged that only one person performs online interactions with the entity on behalf of a given business entity. However, it could also be envisaged that two or more persons perform online interactions with the entity on behalf of the business entity. In this case it may be desirable for the entity to analyse the combined activity, i.e. all online interactions taking place with persons being related to the business entity, in one go, since this may allow the entity to predict a final event and/or a probability of a final event related to the business entity, rather than related to individual persons related to the business entity. For instance, the business entity may be searching the market with respect to a specific product or service, and several persons related to the business entity may be involved in deciding which of the available products or services to be purchased. In this case, the combined behaviour of all of the involved persons will be relevant with regard to the outcome of the process. Therefore it is an advantage that a combined sequence of online interactions is obtained and stored as described above.

The remarks set forth above could equally well be applied to a household comprising two or more persons, or to any other suitable kind of group of persons.

The step of determining whether or not a person is related to a group of persons may comprise analysing an IP address of a device used by the person during the online interaction. Often, a series of related IP addresses will be assigned to a given group of persons, such as a business entity or a household. Thereby it is possible to determine that a person using a device having one of these IP addresses is related to that group of persons. As an alternative, a relationship between a person and a group of persons may be determined in other ways, e.g. by means of a logon process, where the person identifies herself or himself, or in any other suitable manner.

According to a second aspect the invention provides a system for predicting behaviour of a person performing online interactions with an entity, the system comprising:
a registering module arranged to register sequences of online interactions between persons and the entity, arranged to register final events, each final event defining an outcome, and arranged to associate a final event with a sequence of online interactions,
a storage device for storing information regarding sequences of online interactions and associated final events,
a comparing module arranged to compare a partial sequence of one or more online interactions of a person to information regarding sequences of online interactions and associated final events stored in the storage device, and
a prediction module arranged to predict a final event and/or a probability of a final event of a partial sequence of online interactions, based on an output provided by the comparing module.

It should be noted that a person skilled in the art would readily recognise that any feature described in combination with the first aspect of the invention could also be combined with the second aspect of the invention, and vice versa. Thus, the system of the second aspect of the invention could advantageously be used when performing the method of the first aspect of the invention. The remarks set forth above with reference to the first aspect of the invention are therefore equally applicable here.

The system may reside on a server having a website residing thereon. In this case at least some of the online interactions between persons and the entity may be or comprise visits to the website by the person.

The registering module may further be arranged to register offline interactions between the person and the entity. In this case the registered sequences may include online interactions as well as offline interactions between persons and the entity, as described above.

The prediction module may form part of the comparing module. In this case a single module performs the comparison and the prediction. As an alternative, the prediction module and the comparing module may form separate modules arranged to communicate with each other, in order to allow the prediction module to perform predictions on the basis of comparisons performed by the comparing module.

### BRIEF DESCRIPTION OF THE DRAWINGS

The invention will now be described in further detail with reference to the accompanying drawings, in which

FIG. 1 is a diagrammatic view of a system according to an embodiment of the invention,

FIG. 2 is a flow diagram illustrating a method according to a first embodiment of the invention, and

FIG. 3 is a flow diagram illustrating a method according to a second embodiment of the invention.

### DETAILED DESCRIPTION OF THE DRAWINGS

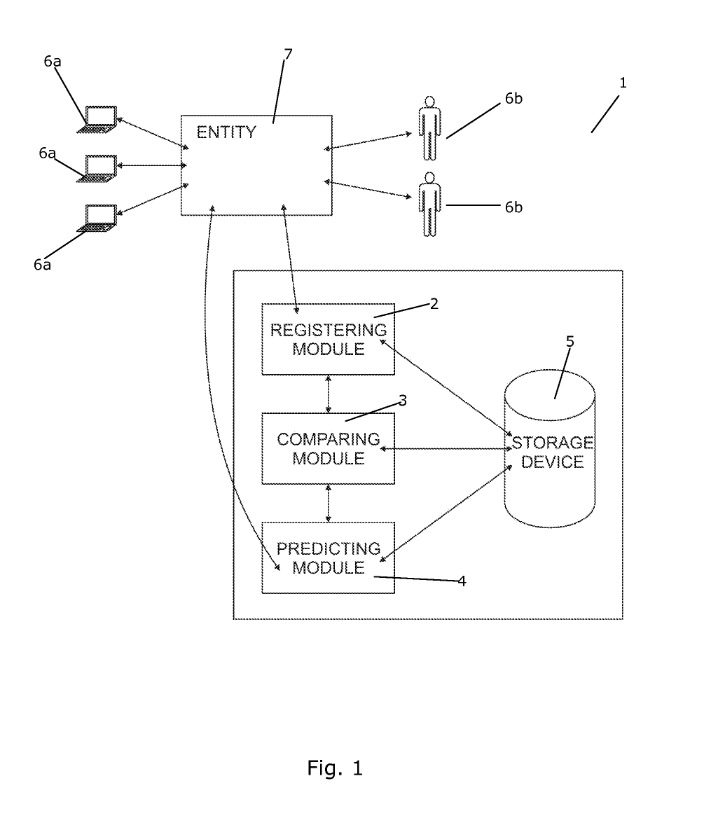

FIG. 1 is a diagrammatic view of a system 1 according to an embodiment of the invention. The system 1 comprises a registering module 2, a comparing module 3, a predicting module 4 and a storage device 5. The system 1 may be residing on a server, e.g. in the form of a single device, or in the form of two or more individual devices being interlinked in such a manner that they, to a person accessing the system, seem to act as a single device.

A number of persons 6a, 6b are able to perform interactions with an entity 7. The entity 7 may, e.g., be a vendor of products and/or services, a website owner, an organization, a company, and/or any other suitable kind of entity needing to perform interactions with persons.

Some of the persons 6a perform online interactions with the entity 7. This may, e.g., take place via a client device communicating with an entity device via a communication network, e.g. a computer network, such as the Internet. The client device may, e.g., be in the form of a personal computer (PC), a cell phone, a tablet, a television, and/or any other suitable kind of device allowing the person 6a to perform online interactions with the entity 7.

The online interactions may, e.g., be or include the person 6a visiting a website belonging to the entity 7 or a representative for the entity 7, the person 6a performing online chats with the entity 7, etc.

Some of the persons 6b perform offline interactions with the entity. This may, e.g., take place using suitable offline communication means. The offline interactions may, e.g., be or include personal meetings, telephone calls and/or mailed purchase offers.

During the interactions between the persons 6a, 6b and the entity 7, the entity 7 collects information regarding each of the interactions. The information may, e.g., include time of the interaction, duration of the interaction, actions taking place during the interaction, navigations taking place during the interaction (in the case that the interaction includes a visit to a website), etc.

The collected information is communicated to the registering module 2, and the registering module 2 registers relevant information. The communication of information from the entity 7 to the registering module 2 may take place in a running fashion, during the interaction. In this case the information is simply communicated to the registering module 2 as and when it is available to the entity 7. As an alternative, the entity 7 may collect and store the information locally, and communicate all relevant information regarding the interaction to the registering module 2 when the interaction has been completed.

The registering module 2 further registers sequences of interactions performed by each of the persons 6a, 6b. A sequence of interactions includes interactions taking place between an initial contact between the person 6a, 6b and the entity 7, and a final event defining an outcome. The kinds of events to be regarded as a ‘final event’ may be defined by the entity 7, and will typically be selected in such a manner that they reflect outcomes which the entity 7 regards as desired or undesired. A sequence of interactions may include only online interactions, only offline interactions, or online interactions as well as offline interactions.

Furthermore, the registering module 2 registers final events and associates the final events with sequences of interactions. A final event may, e.g., be or include placing a purchase order, requesting a demo, closing a service agreement, signing up for a newsletter, abandonment, loss, etc.

The registering module 2 communicates the registered information to the storage device 5 where it is stored. Thus, the storage device 5 stores information regarding completed sequences of interactions and associated final events for a plurality of persons 6a, 6b. Thus, the information stored in the storage device 5 constitutes a ‘bank’ of information regarding how the interacting persons 6a, 6b interacted with the entity 7, leading up to a final event, and what the outcome of the interactions was.

Next a further person 6a, 6b is allowed to perform interactions with the entity 7. As described above, the entity 7 collects information regarding the interaction(s) and communicates the collected information to the registering module 2, where the information is registered in the form of a partial sequence of interactions.

The information regarding the partial sequence of interactions is communicated to the comparing module 3. The information may in addition be communicated to the storage device 5 and stored.

Upon receiving registered information regarding a partial sequence of interactions from the registering module 2, the comparing module 3 retrieves stored information regarding sequences of interactions and final events from the storage device 5. The comparing module 3 then compares the information regarding the partial sequence of interactions, received from the registering module 2, to the information retrieved from the storage device 5. In particular, the comparing module 3 may search for sequences of interactions which contain sub-sequences being identical or similar to the partial sequence of interactions received from the registering module 2.

The result of the comparison is communicated to the predicting module 4. Based on the comparison, the predicting module 4 predicts a final event which will, in the future, complete the partial sequence of interactions. Alternatively or additionally, the predicting module 4 may predict a probability that a given final event will complete the partial sequence. The predicting module 4 communicates the prediction to the entity 7, and the entity 7 may use the prediction for adjusting its behaviour towards the person 6a, 6b, e.g. as described above, in order to maximise the likelihood of a desired outcome of the interactions with the person 6a, 6b.

Even though the comparing module 3 and the predicting module 4, in FIG. 1, are illustrated as two separate modules arranged to communicate with each other, it is noted that the comparing module 3 and the predicting module 4 may, alternatively, form a single module arranged to perform the comparison as well as the prediction.

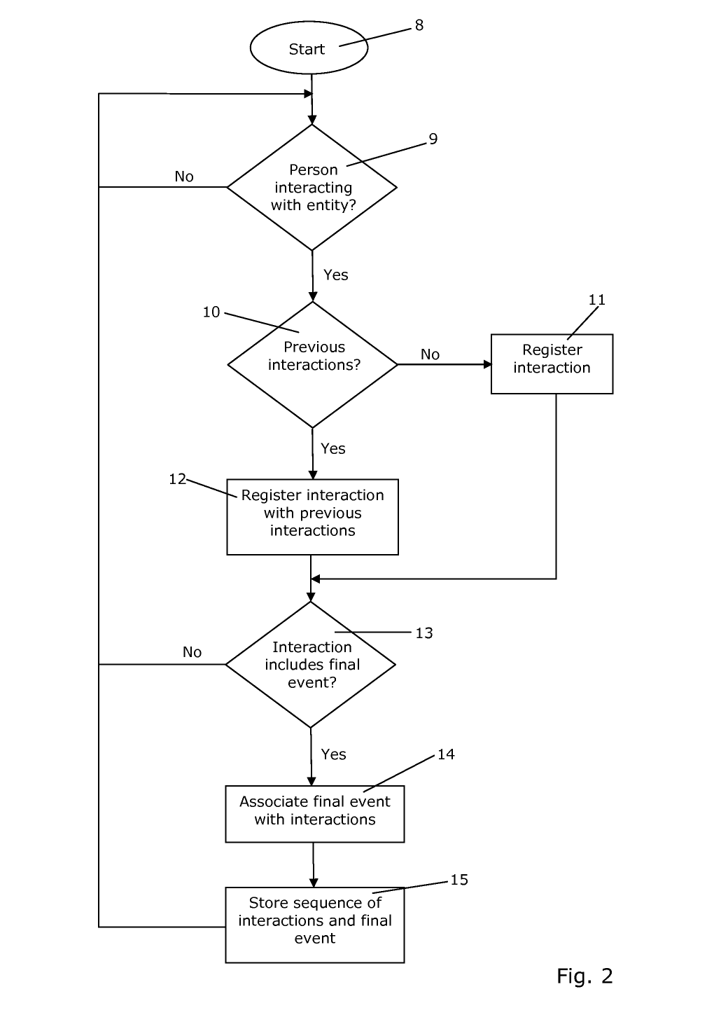

FIG. 2 is a flow diagram illustrating a method according to a first embodiment of the invention. The process is started at step 8. At step 9 it is investigated whether or not a person is interacting with the entity. If this is not the case, the process is returned to step 9 for continued monitoring of interactions.

If step 9 reveals that a person is currently interacting with the entity, the process is forwarded to step 10, where it is investigated whether or not the person has previously interacted with the entity. If this is not the case, it is determined that the interaction constitutes an initial contact between the person and the entity, and the process is forwarded to step 11, where the interaction is registered.

If step 10 reveals that the person has previously performed interactions with the entity, the process is forwarded to step 12. At step 12 the interaction is registered along with the previous interactions, i.e. the previous interactions and the present interaction together form at least a part of a sequence of interactions.

Steps 12 and 13 may further include storing the registered interactions, and possibly information relating to the interaction, in a storage device for later use.

Once the interaction has been registered, and possibly stored, at step 11 or step 12, it is investigated whether or not the interaction includes a final event, at step 13. The interaction itself could constitute a final event. Alternatively, the final event may be an event or action taking place during the interaction.

If step 13 reveals that the interaction does not include a final event, it is concluded that the sequence of interactions is not a complete sequence, and the process is returned to step 9 for continued monitoring for interactions.

If step 13 reveals that the interaction includes a final event, the final event is associated with the interactions, at step 14. Thereby the registered interactions form a complete sequence of interactions, having a final event associated therewith.

It should be noted that the final event could be included in an online interaction or an offline interaction, depending on the kind of final event.

Finally, information regarding the registered sequence of interactions is stored along with information regarding the final event in a storage device, at step 15, before the process is returned to step 9 for continued monitoring for interactions. In the case that interactions were stored at steps 11 and 12, this may simply be done by adding information regarding the final event to the information which is already stored about the sequence of interactions.

Accordingly, FIG. 2 illustrates a method in which complete sequences of interactions and final events are registered, and information regarding the sequences and the final events associated with the sequences is stored in a storage device. The information stored in this manner provides a ‘bank’ of relevant information regarding interactions leading up to an outcome in the form of a final event.

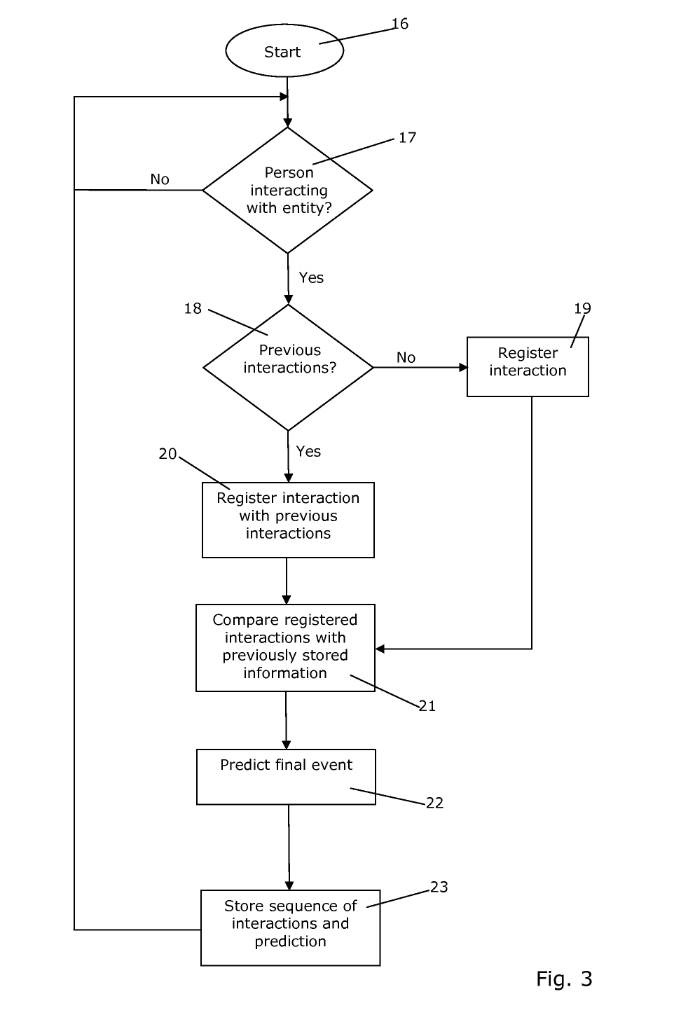

FIG. 3 is a flow diagram illustrating a method according to a second embodiment of the invention. Steps 16, 17, 18, 19 and 20 are performed essentially as steps 8, 9, 10, 11 and 12 of FIG. 2. These steps will therefore not be described further here.

At step 21 the interactions which were registered, and possibly stored, at step 19 and step 20 are compared with previously stored information regarding registered sequences of interactions and final events. The previously stored information may advantageously have been obtained by means of the method illustrated in FIG. 2 and as described above. As described above, the comparison may, e.g., include identifying stored sequences of interactions comprising a sub-sequence which is identical or similar to the partial sequence of interactions which is currently being registered. Alternatively or additionally, the comparison may include an analysis of the stored information and/or of the partial sequence of interactions which is currently being registered.

The process is then forwarded to step 22, where a final event for the registered sequence of interactions is predicted. The predicted final event represents a probable outcome of the interactions between the person and the entity. The prediction is performed on the basis of the result of the comparison. Thereby the prediction is performed on the basis of actual behaviour of persons who have previously interacted with the entity, and there is therefore a high probability that the prediction is correct. As described above, the entity may use the prediction as a basis for adjusting its behaviour towards the person, e.g. in order to prevent an undesired outcome of the interactions and/or in order to increase the probability of a desired outcome of the interactions.

Finally, the partial sequence of interactions is stored along with the prediction of the final event, before the process is returned to step 17 for continued monitoring for interactions.

1. A method for predicting behaviour of a person performing online interactions with an entity, the method comprising the steps of:
allowing a plurality of persons to perform online interactions with the entity,
for each person:
registering a sequence of one or more online interactions between the person and the entity, said online interaction(s) taking place between an initial contact between the person and the entity, and a final event,
registering a final event, said final event defining an outcome,
associating the final event with the sequence of online interactions, and storing information regarding the sequence of online interactions along with information regarding the final event in a storage device,
allowing a further person to perform online interactions with the entity,
registering one or more online interactions between the further person and the entity, said one or more online interaction(s) forming a partial sequence of online interactions,
comparing the partial sequence of online interactions to previously stored information regarding sequences of online interactions and final events, and
predicting a final event and/or a probability of a final event of the partial sequence of online interactions, based on said comparing step.

2. The method according to claim 1, wherein at least some of the online interactions are visits to a website by the person.

3. The method according to claim 1, wherein the information being stored regarding the sequence of online interactions comprises: time of interactions, duration of interactions, actions performed during interactions, time lapsing between interactions, location of the person, means of online interaction, value generated during interactions, content viewed by the person during interactions and/or time lapsing while viewing content.

4. The method according to claim 1, wherein the step of storing information regarding the sequence of online interactions comprises storing information regarding events taking place during at least one online interaction.

5. The method according to claim 1, wherein the final events are selected from a group consisting of: purchase, abandonment, requesting a demo, downloading an asset, signing up for a newsletter, unsubscribing from a newsletter, filling in a form, a revenue and a loss.

6. The method according to claim 1, further comprising the steps of for one or more of the plurality of persons and/or for the further person:
registering one or more offline interactions between the person and the entity,
associating the offline interaction(s) with the sequence of online interactions, and
storing information regarding the offline interaction(s) along with the information regarding the sequence of online interactions and the information regarding the final event.

7. The method according to claim 6, wherein the offline interaction(s) is/are selected from a group consisting of: telephone contact, meeting, mailed purchase offer, in-store visit and tradeshow.

8. The method according to claim 6, wherein the step of comparing the partial sequence of online interactions to previously stored information regarding sequences of interactions and final events further comprises comparing registered offline interactions of the further person to stored information regarding offline interactions.

9. The method according to claim 1, wherein the step of comparing the partial sequence of online interactions to previously stored information regarding sequences of interactions and final events comprises identifying one or more stored sequences of online interactions comprising a sub-sequence which is identical or similar to the partial sequence.

10. The method according to claim 1, wherein the step of comparing the partial sequence of online interactions to previously stored information regarding sequences of online interactions and final events comprises analysing the stored information and/or the partial sequence of online interactions.

11. The method according to claim 10, further comprising the step of estimating a number of persons being unknown to the entity becoming known to the entity within a predefined time period, based on the analysis step.

12. The method according to claim 10, further comprising the step of storing the result of the analysis in the storage device.

13. The method according to claim 10, wherein the step of analysing comprises analysing time lapsing between interactions and/or time lapsing between interactions and final events.

14. The method according to claim 1, further comprising the step of storing information regarding an online interaction in the storage device each time an online interaction has taken place.

15. The method according to claim 1, further comprising the steps of:
for each person performing online interactions with the entity, determining whether or not the person is related to a group of persons,
in the case that it is determined that the person is related to a group of persons, associating the online interactions performed by the person to sequences of online interactions performed by other persons being related to said group of persons, thereby obtaining a combined sequence of online interactions being associated to said group of persons, and
storing information relating to the combined sequence of online interactions along with information regarding final events being associated to sequences of online interactions forming part of the combined sequence of online interactions.

16. The method according to claim 15, wherein the step of determining whether or not a person is related to a group of persons comprises analysing an IP address of a device used by the person during the online interaction.

17. A system for predicting behaviour of a person performing online interactions with an entity, the system comprising:
a registering module arranged to register sequences of online interactions between persons and the entity, arranged to register final events, each final event defining an outcome, and arranged to associate a final event with a sequence of online interactions,
a storage device for storing information regarding sequences of online interactions and associated final events,
a comparing module arranged to compare a partial sequence of one or more online interactions of a person to information regarding sequences of online interactions and associated final events stored in the storage device, and
a prediction module arranged to predict a final event and/or a probability of a final event of a partial sequence of online interactions, based on an output provided by the comparing module.

18. The system according to claim 17, wherein the system resides on a server having a website residing thereon.

19. The system according to claim 17, wherein the registering module is further arranged to register offline interactions between the person and the entity.

20. The system according to claim 17, wherein the prediction module forms part of the comparing module.
